(19) United States
(12) Patent Application Publication
(10) Pub. No.: US 2012/0132284 A1
(43) Pub. Date: May 31, 2012

(54) METHOD, CONTROLLER, VALVE ARRANGEMENT AND PORTIONING DEVICE FOR PORTIONING A FLOWABLE, OPTIONALLY PRESSURIZED MASS

(76) Inventor: Leo Bühler, Wadenswill (CH)

(21) Appl. No.: 13/201,161

(22) PCT Filed: Feb. 10, 2010
(86) PCT No.: PCT/IB10/50612

§ 371 Date: Nov. 7, 2011

(30) Foreign Application Priority Data
Feb. 13, 2009 (CH) 0237/09

(51) Int. Cl. F15D 1/00

(52) U.S. Cl. 137/1; 137/613

(57) ABSTRACT

A method is provided for portioning a flowable, optionally pressurized mass. In a first step a first pinch valve is opened and a second pinch valve located thereafter in a principal flow direction of the mass (m) is slightly closed. As soon as a desired quantity of the mass has passed the pinch valves the first pinch valve is closed. The second pinch valve is then opened. The opening, the slight closing and the closing of the first pinch valve and of the second pinch valve is accomplished by a pressure medium. A controller, a valve arrangement and a portioning device are also provided for executing the method.

The invention relates to a method for portioning a flowable, optionally pressurized mass by opening and closing a pinch valve. The invention further relates to a controller for portioning a flowable, optionally pressurized mass, comprising means for controlling a pinch valve. Finally, the invention relates to a valve arrangement and a portioning device for portioning a flowable, optionally pressurized mass, comprising a pinch valve.

In modern plant construction there are many applications in which a flowable mass must be portioned. As an example, mention is made here of the food industry which pours a large range of different foodstuffs into equally different containers or casts them in moulds. Examples for this are meat pastes, cooked vegetables such as, for example, spinach, pureed fruit, all types of dough, creams and chocolate. However, flowable masses are also found in other technical fields. For example, concrete or clay must also be portioned when concrete blocks or bricks are cast. Plastics technology is mentioned as another example in which liquid plastic is cast in moulds, in particular for potting electronic components or circuits. Finally, granular materials, in particular mixed with a binder, are also portioned or filled or cast in industrial installations. It is obvious that not all possible portioning devices can be mentioned at this point. The above list is therefore to be understood as an illustrative listing of such devices.

As a specific example of a portioning device, WO 2008/141468 discloses an apparatus and a method for casting an edible product from a castable mass, in particular a fat mass such as, for example, chocolate. The casting apparatus contains a mass container for receiving the castable mass and a metering unit with nozzles, which is in fluid communication with the mass container interior. The metering unit has a nozzle block with nozzles on the side facing away from the mass container and a valve block with at least one valve on the side facing the mass container, a metering chamber being delimited between the nozzle block and the valve block and having a metering chamber volume that can be changed by a relative motion between the nozzle block and the valve block. The casting method comprises the following steps: a) filling the mass container with the castable mass; b) drawing the mass into the metering chamber by enlarging the metering chamber volume by a first relative motion between the nozzle block and the valve block; c) discharging mass from the metering chamber by reducing the metering chamber volume by a second relative motion between the nozzle block and valve block.

In the above example, a pressure-less mass is portioned. In precise terms, due to the claimed relative motion between the nozzle block and the valve block, on the one hand pressure is built up to discharge the mass, on the other hand the discharged mass is determined simultaneously. The same also applies to other piston mechanisms known per se or also geared pumps. In modern plant construction, however, pressurised masses are frequently also portioned. This is accomplished by most diverse shutoff mechanisms and valves which can reduce and enlarge or even shut off the mass flow. So-called “pinch valves” have proved particularly suitable for this purpose.

Pinch valves consist of a tubular shutoff element that is disposed in a tube-shaped housing made of metal or plastic. The tubular shutoff element is either pinched together mechanically or by an external medium supplied from outside, until the closed position is reached. The external medium usually has a pressure about 2.0 to 2.5 bar higher than the medium that is to be shut off. Pinch valves are primarily used as shutoff fittings for thick-liquid media or solids. Due to various tubular sleeve designs, pinch valves are suitable for controlling very different media.

In more or less all portioning devices, the after-run or dripping of the mass is now problematical. Although, for example, the piston of a portioning device is already at a standstill or a valve of a portioning device is already shut off, mass still flows through the lines behind the piston or the shutoff valve or drips from the line if this, possibly in the form of a nozzle, opens into a free surrounding area. This is caused on the one hand by excess pressure prevailing in the line as previously, which can only be reduced slowly, or also due to various physical effects at a line end or nozzle outlet.

It is now the object of the invention to provide a method, a controller, a valve arrangement and a portioning device for portioning a flowable, optionally pressurized mass, in which the mentioned disadvantages do not occur or are at least lessened.

This object is solved according to the invention by a method having the features of patent claim 1, a controller according to the features of patent claim 6, a valve arrangement having the features of patent claim 8 and with a portioning device having the features of patent claim 15.

Accordingly, the method according to the invention for portioning a flowable, optionally pressurized mass, comprises the steps:

a) opening a first pinch valve and slightly closing a second pinch valve located thereafter in a principal flow direction of the mass,
b) closing the first pinch valve when the desired quantity of the mass has passed the pinch valves and
c) opening the second pinch valve, whereby the opening, the slight closing and the closing of the first pinch valve and/or of the second pinch valve is accomplished by a pressure medium.

Accordingly, a controller according to the invention for portioning a flowable, optionally pressurized mass, comprises means for controlling:

a) a first pinch valve into an open position and a second pinch valve located thereafter in a principal flow direction of the mass into a slightly closed position,
b) the first pinch valve into a closed position when a desired quantity of the mass has passed the pinch valves and
c) the second pinch valve into a further opened position compared with the slightly closed position, whereby the opening, the slight closing and the closing of the first pinch valve and/or of the second pinch valve is accomplished by a pressure medium.

Furthermore, a valve arrangement according to the invention for portioning a flowable, optionally pressurized mass, comprises:
a plurality of first pinch valves and
second pinch valves arranged thereafter in a principal flow direction of the mass.

Finally, a portioning device according to the invention for portioning a flowable, optionally pressurized mass, comprises:
a valve arrangement according to the invention and
a controller according to the invention connected to said arrangement.

Due to the opening of the second pinch valve after the first pinch has been closed or is in the course of closing, an increase in volume is accomplished in the region of the second pinch valve and therefore a pressure drop or a vacuum is accomplished in the pinch valve. A mass flow is therefore stopped very rapidly or the running out or dripping from any nozzle mounted behind the second pinch valve is prevented or at least drastically reduced.

Furthermore, the valve arrangement can be very easily cleaned. A flushing in the mounted state is usually sufficient since the valve arrangement has a smooth inner side. As a result of the lack of gaps such as occur, for example, in conventional valves or between piston and cylinder, in the valve arrangement according to the invention the tendency to form bacteria is also significantly reduced, which is particularly important for the food industry. In the valve arrangement according to the invention there is furthermore a lack of moving parts with surfaces rubbing against one another. The valve arrangement is therefore largely maintenance-free. Finally, if necessary, the valve arrangement can also be heated in order, for example, to make the mass to be portioned more runny. To this end, an internally or externally arranged heating means can be provided, which for example heats the pressure medium or the pressure chamber. Advantageously, an electrical heating means or a water circuit is provided, which, for example, is a component of the apparatus already provided or an additional component arranged on the apparatus. In this way, the mass can be conveyed, injected or cast with lower energy expenditure without the risk of dripping thereby increasing substantially. The invention therefore also contributes to the energy efficiency.

At this point, it is pointed out that the pressurization must not necessarily be accomplished by technical measures, i.e., for example, with the aid of a compressor. The pressurisation can also be achieved by gravity if a container containing the mass to be portioned is located above an outlet point, possibly an injection nozzle.

Advantageous embodiments and further developments of the invention are obtained from the dependent claims and from the description when viewed together with the figures in the drawings.

It is favourable if after step c), step a) is repeated again. In this way, the portioning process can be repeated arbitrarily frequently.

It is furthermore favourable if the mass flows out into a surrounding area after the second pinch valve. As already mentioned, after the second pinch valve, the mass can flow out into a surrounding area, for example, via a nozzle. For example, moulds can thus be filled with the flowable mass. Within the framework of the invention, “surrounding area” is understood to be a space in which the pressurization of the mass which brings about its conveyance, is no longer effective. However, surrounding area does not necessarily mean a space in which atmospheric pressure prevails. Surrounding areas are also feasible which are at higher or lower pressure. It is advantageous in this context if one/several nozzle/nozzles opening into a surrounding area is/are arranged after the second pinch valve in the principal direction of flow of the mass.

It is advantageous if the flowable mass consists of chocolate or contains this. Dripping is particularly troublesome if comparatively small quantities and/or comparatively expensive masses are injected or cast. Chocolates or chocolate bars satisfy both criteria so that the method according to the invention is particularly suitable for the processing of chocolate or chocolate-containing masses. Furthermore, the method according to the invention, the controller according to the invention and the valve arrangement according to the invention as well as the portioning arrangement according to the invention are suitable for all types of flowable masses, in particular further masses from the food industry such as, for example, butter, yoghurt or water.

It is particularly advantageous if the valve arrangement comprises a plurality of first pinch valves and second pinch valves located thereafter in the principal flow direction of the mass. By means of this variant of the invention, many portions of the same type can be produced simultaneously, i.e. within one work cycle. It is advantageous if the first pinch valves and/or second pinch valves can be actuated simultaneously by one controller.

It is furthermore particularly advantageous if the first pinch valves are arranged in a first pressure chamber. In this way, a plurality of pinch valves can be acted upon simultaneously by the same pressure. An expensive pipe network for supplying the first pinch valves with the first control medium can therefore be omitted. The same applies as appropriate for the second pinch valves which are advantageously located in a second pressure chamber.

At this point, it is noted that the embodiments specified for the method according to the invention and the resulting advantages relate equally to the controller according to the invention, the valve arrangement according to the invention and the portioning device according to the invention and conversely.

The above embodiments and further developments of the invention can be combined in any manner.

The present invention will be explained in detail hereinafter with reference to the exemplary embodiments given in the schematic figures in the drawings. In the figures:

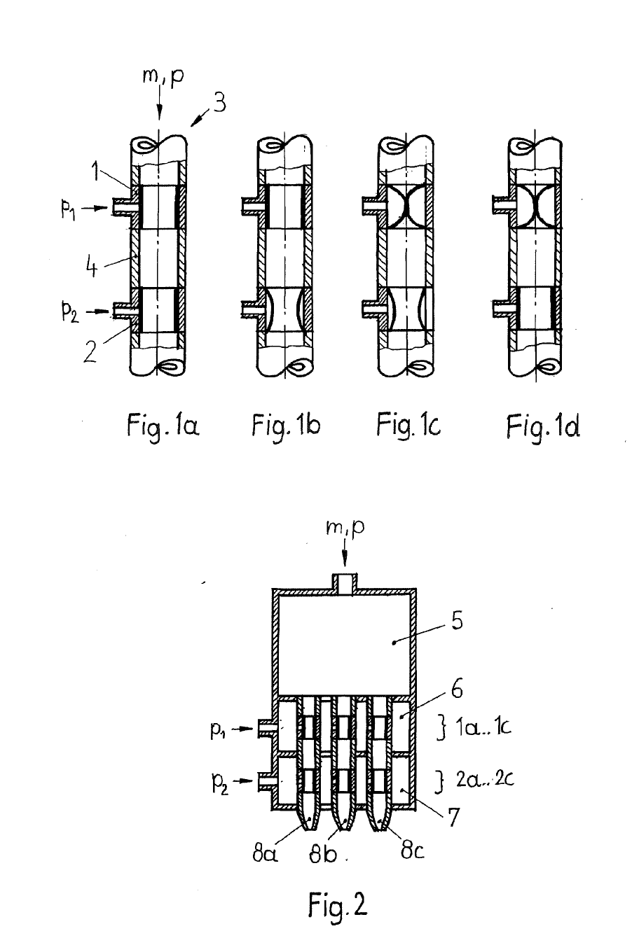

FIG. 1a shows a first valve arrangement shown schematically;

FIG. 1b shows the valve arrangement from FIG. 1a in a first state;

FIG. 1c shows the valve arrangement from FIG. 1a in a second state;

FIG. 1d shows the valve arrangement from FIG. 1a in a third state;

FIG. 2 shows an arrangement comprising a mass container and a plurality of first and second pinch valves;

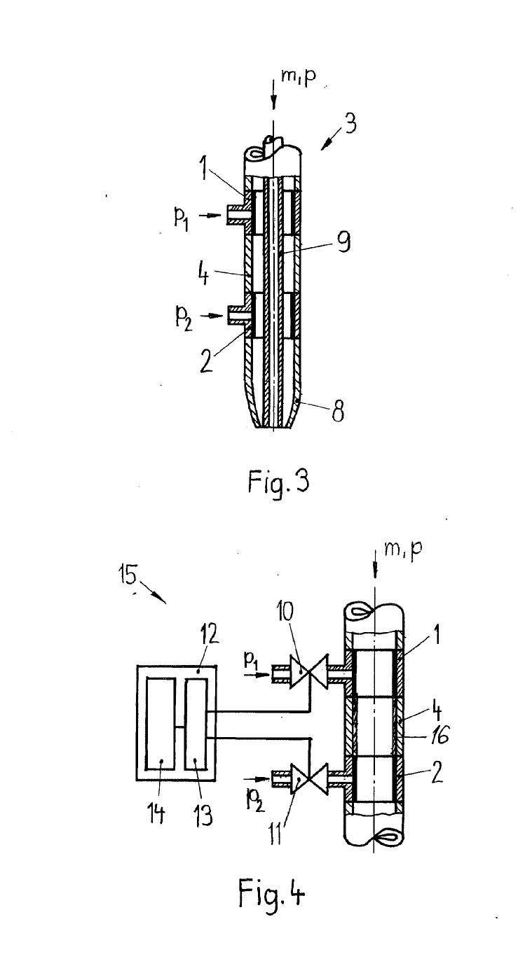

FIG. 3 shows a valve arrangement with a central pipe;

FIG. 4 shows a portioning device with a valve arrangement and a controller connected thereto.

In the figures in the drawings, the same or similar parts are provided with the same reference numbers and functionally similar elements and features, unless stated otherwise, are provided with the same reference numbers but different subscripts.

FIG. 1a shows a first valve arrangement 3 depicted schematically, which comprises a pipe 4, as well as a first pinch valve 1 arranged in the course of the pipe 4 and a second pinch valve 2 arranged in the course of the pipe 4. A flowable mass m flows through the pipe 4, which in this exemplary embodiment is acted upon by a pressure p. The principal direction of flow is symbolized by an arrow. The first pinch valve 1 comprises a control connection through which a control medium having a first control pressure p₁ can flow. Finally, the second pinch valve 2 comprises a control connection through which a control medium having a second control pressure p₂ can flow.

The two pinch valves 1 and 2 are of a design known per se. In the example shown, these are to be controlled with compressed air. In principle, however, other control media are possible for actuating the pinch valves 1 and 2. A flexible tubular membrane (shown by a thick line) can be deformed by the compressed air in such a manner that the cross-section of the valve can be narrowed or this can even be shut off. The first and second control pressure p₁ and p₂ must therefore be selected correspondingly higher than the pressure of the mass p. In FIG. 1a no control pressures p₁ or p₂ are acting so that the membranes of the first and second pinch valves 1 and 2 adopt their rest position and abut against the inner side of the outer valve tube.

In FIG. 1a the membranes of the first and second pinch valve 1 and 2 narrow the pipe cross-section. This is, however, not a mandatory design. Naturally, the membrane can also be arranged in the course of the pipe 9, that is, it can be aligned with this. In addition, circular pipe cross-sections are shown in FIG. 1a and the following figures. This is also not absolutely necessary. Naturally, the invention can also be applied to different pipe cross-sections, for example, rectangular, polygonal or elliptical.

FIG. 1b now shows the valve arrangement 3 from FIG. 1a in a first state a). In this case, the first pinch valve 1 is fully open and the second pinch valve 2 is incompletely, and therefore slightly, closed. This can be accomplished with corresponding control pressures p₁ and p₂. Accordingly, the mass m can pass through the valve arrangement 3.

FIG. 1c shows the valve arrangement 3 from FIG. 1a in a second state b). In this case, the first pinch valve 1 is closed. The volume flow is now stopped. The valve arrangement 3 is thereby controlled into the second state b) when sufficient mass m has flowed through the valve arrangement 3, that is, the mass m is portioned in the desired manner.

FIG. 1d now shows the valve arrangement 3 from FIG. 1a in a third state c). In this case, the first pinch valve 1 remains closed whilst the second pinch valve 2 is fully open. Due to this process the volume in the valve arrangement 3 is enlarged so that the pressure on the mass m is reduced or the mass m even moves slightly in the direction opposite the direction of flow, i.e. is sucked back. This is of particular advantage when the mass m flows into a surrounding area after passing the valve arrangement 3. Surrounding area can be understood in this context as any space in which the pressurization of the mass m is no longer acting. The mass m will frequently flow out into a free surrounding area in which atmospheric air pressure prevails. In principle, however, the mass m can also flow into a closed space. Due to the suction effect of the opening second pinch valve, any dripping such as frequently occurs in solutions according to the prior art is advantageously avoided. After the third state c) the cycle can begin again from the beginning at the first state a).

At this point, it is noted that the process described also functions when the second pinch valve 2 in the third state c) is not fully but only partially open since only the change of volume and the associated pressure reduction or suction effect is important. It is further noted that the first state a) (after the third state c) can be reached both by simultaneously actuating the pinch valves 1 and 2 and also by sequentially actuating the same. In this case, for example, the first pinch valve 1 can be opened and then the second pinch valve 2 slightly closed. However, the slight closing of the second pinch valve 2 before opening the first pinch valve 1 is also possible.

FIG. 2 now shows schematically an arrangement in which the mass m acted upon by a pressure p flows into a mass container 5 from whence it flows through a plurality of first pinch valves 1a . . . 1c, second pinch valves 2a . . . 2c and finally through nozzles 8a . . . 8c into the open air. In this arrangement the first pinch valves 1a . . . 1c are located in a first pressure chamber 6 and are actuated simultaneously by acting upon the first pressure chamber 6 with the first control pressure p₁. Similarly, the second pinch valves 2a . . . 2c are located in a second pressure chamber 7 and are actuated simultaneously by acting upon the second pressure chamber 7 with the second control pressure p₂.

On account of the pressure chambers 6 and 7, the control openings of the pinch valves 1a . . . 1c and 2a . . . 2c do not need to be further connected to a pipe network, a simple bore is sufficient. However, it is also feasible that the pinch valves 1a . . . 1c and 2a . . . 2c only consist of an elastic tube or hose that is compressed by increasing the control pressure p₁ or p₂. The rigid outer pipe, as shown in FIG. 1a to FIG. 1d can therefore be omitted in principle. It is also feasible that a heatable medium is located in the first and/or second pressure chamber 6 and 7, which also heats the flowable mass m by means of the first and second pinch valves 1a . . . 1c and 2a . . . 2c.

The function of the arrangement shown in FIG. 2 is the same as the function of the valve arrangement 3 shown in FIG. 1a to FIG. 1d, except that here a plurality of valve arrangements 3 is actuated simultaneously. This arrangement is therefore particularly suitable when the mass m is to be divided in one work cycle into a plurality of equal-sized portions. For example, a plurality of moulds can be filled simultaneously.

FIG. 3 now shows schematically another embodiment of a valve arrangement 3 in which a central pipe 9 is additionally guided to a nozzle 8 connected to the valve arrangement 3. With the aid of this arrangement, two different types of flowable masses can be injected simultaneously or in a time-shifted manner. In a first variant the central pipe 9 is rigid, therefore then remains open when the first and second pinch valve 1 or 2 is closed. In a second variant the central pipe 9 is flexible or has flexible sections at least in the area of the pinch valves 1 or 2. The mass flow through the central pipe 9 can then be influenced by the first and second control pressure p1 and/or p2. Naturally rigid bodies such as possibly sugar balls having a liquid core or nuts can be conveyed through the central pipe 9, which are then overmoulded with, for example, chocolate.

FIG. 4 finally shows schematically a portioning device 15 in which a controller 12 is connected to a first control valve 10 and a second control valve 11. The control valves 10 and 11 can, for example, comprise electromagnetic valves. In principle, however, other designs can also be used equally.

The controller 12 actuates the control valves 10 and 11 according to the work cycle and can in particular cooperate with a superordinate controller or part of the same.

For the sake of simplicity the control valves 10 and 11 are only provided for the ventilation of the first and second pinch valve 1 and 2. Naturally measures (not shown) should also be taken for venting, for example, additional venting valves. Instead of the control valves 10 and 11, which allow a control medium acted upon by the first or second control pressure p₂, p₂, to pass or not, pistons displaceable in cylinders can also be provided, which press the control medium into the first and second pinch valve 1 or 2 or suck this out from this valve again.

The first pinch valve 1 and the second pinch valve 2 arranged thereafter in the principal direction of flow of the mass m are interconnected via a central section 16 so that these are formed in one piece. The central section 16 is advantageously fixed to the inner wall of the pipe 4 at least in certain areas.

In the example shown, the controller 12 itself comprises a central processing unit 13 and a memory 14 connected to this. The necessary steps for carrying out the method according to the invention and the variables required for this are stored, for example, in the memory. It is naturally also feasible that the method according to the invention is imaged in hardware, possibly with the aid of corresponding logic gates. Finally, a mixed design in soft- and hardware is also feasible. As already mentioned, the controller 12 can cooperate with a superordinate controller or part of the same. It is also feasible that the valve arrangement 3 or several valve arrangements 3 are part of a commercial installation, which can be operated by a central controller.

The invention is suitable for a plurality of applications, for example, in the food industry for the portioning of meat pastes, pureed vegetables or fruit, dough, creams and in particular also chocolate. However, an application in the production of concrete blocks or bricks is also feasible.

Finally, an application for the portioning of liquid plastics as well as granular materials which are in particular mixed with a binder is feasible. Finally, it is noted that the examples given should not be understood as a restriction of the area of application of the invention. On the contrary, they serve as a suggestion for the person skilled in the art who can easily find other areas of application here and adapt the invention to his needs.

### REFERENCE LIST

1, 1a . . . 1c First pinch valve
2, 2a . . . 2c Second pinch valve
3 Valve arrangement
4 Pipe
5 Mass container
6 First pressure chamber
7 Second pressure chamber
8, 8a . . . 8c Nozzle
9 Central pipe
10 First control valve
11 Second control valve
12 Controller
13 Central processing unit
14 Memory
15 Portioning device
16 Central section
m Mass
p Pressure of the mass
p₁ First control pressure
p₂ Second control pressure

1. A method for portioning a flowable, optionally pressurized mass, comprising the steps of:
a) opening a first pinch valve and slightly closing a second pinch valve located thereafter in a principal flow direction of the mass,
b) closing the first pinch valve when a desired quantity of the mass has passed the pinch valves; and
c) opening the second pinch valve, wherein the opening, the slight losing and the closing of the first pinch valve and/or of the second pinch valve is accomplished by a pressure medium.

2. The method according to claim 1, wherein after step c), step a) is repeated.

3. The method according to claim 1, wherein the mass flows out into a surrounding area after the second pinch valve.

4. The method according to claim 1, wherein the flowable mass includes chocolate.

5. The method according to claim 1, wherein the flowable mass is heated.

6. A controller for portioning a flowable, optionally pressurized mass, comprising
a) means for controlling a first pinch valve into an open position and a second pinch valve located thereafter in a principal flow direction of the mass into a slightly closed position,
b) means for controlling the first pinch valve into a closed position when a desired quantity of the mass has passed the pinch valves; and
c) means for controlling the second pinch valve into a further opened position compared with the slightly closed position, wherein the opening, the slight closing and the closing of the first pinch valve and/or of the second pinch valve is accomplished by a pressure medium.

7. The controller of claim 6, wherein the means for controlling are provided for the simultaneous control of a plurality of first pinch valves and/or a plurality of second pinch valves.

8. A valve arrangement for portioning a flowable, optionally pressurized mass, comprising:
a plurality of first pinch valves and
second pinch valves arranged thereafter in a principal flow direction of the mass.

9. The valve arrangement according to claim 8, wherein the first pinch valves are disposed in a first pressure chamber.

10. The valve arrangement according to claim 9, wherein the second pinch valves are disposed in a second pressure chamber.

11. The valve arrangement according to claim 8, wherein the first pinch valve and the second pinch valve located thereafter in a principal flow direction of the mass are formed in one piece.

12. The valve arrangement according to claim 8, wherein one or more nozzles opening into a surrounding area are located downstream of the second pinch valves in the principal flow direction of the mass.

13. The valve arrangement according to claim 8, wherein the flowable mass includes chocolate.

14. The valve arrangement according to claim 8, further comprising a heating means for heating the flowable mass.

15. A portioning device for portioning a flowable, optionally pressurized mass, comprising:
a plurality of first pinch valves;
second pinch valves arranged thereafter in a principal flow direction of the mass;
means for controlling the first pinch valves into an open position and the second pinch valves located thereafter in a principal flow direction of the mass into a slightly closed position;
means for controlling the first pinch valves into a closed position when a desired quantity of the mass has passed the pinch valves; and
means for controlling the second pinch valves into a further opened position compared with the slightly closed position, wherein the opening, the slight closing and the closing of the first pinch valves and/or of the second pinch valves is accomplished by a pressure medium.

16. The portioning device according to claim 15, wherein at least one of:
the first pinch valves are disposed in a first pressure chamber;
the second pinch valves are disposed in a second pressure chamber; and
the first pinch valve and the second pinch valve located thereafter are in a principal flow direction of the mass are formed in one piece.

17. The portioning device according to claim 15, wherein one or more nozzles opening into a surrounding area are located downstream of the second pinch valves in the principal flow direction of the mass.

18. The portioning device according to claim 15, wherein the flowable mass includes chocolate.

19. The portioning device according to claim 15, further comprising a heating means for heating the flowable mass.
